(19) United States
(12) Patent Application Publication
(10) Pub. No.: US 2007/0006896 A1
(43) Pub. Date: Jan. 11, 2007

(54) AUTOMATIC CLEANING DEVICE FOR METAL MASK, AND CONTROL METHOD THEREOF

(75) Inventors: YANG CHUN NOU, Icheon-si (KR); YONG CHEOL CHOI, Icheon-si (KR)

Correspondence Address: PARK LAW FIRM, 3255 WILSHIRE BLVD, SUITE 1110, LOS ANGELES, CA, 90010, US

(73) Assignee: HYUNDAI AUTONET CO., LTD., Icheon-si (KR)

(21) Appl. No.: 11/162,354

(22) Filed: Sep. 7, 2005

(30) Foreign Application Priority Data
Jul. 5, 2005 (KR) 10-2005-0060251

(51) Int. Cl. B08B 7/04; B08B 3/00; B08B 3/04

(52) U.S. Cl. 134/10; 134/94.1; 134/104.2; 134/198; 134/18; 134/34; 134/26

(57) ABSTRACT

An automatic cleaning device for a metal mask and a control method thereof are provided. The device includes a temperature controller for maintaining and increasing a temperature of cleaning solution; a first cleaner for keeping, circulating and spraying the cleaning solution mixable with water, and cleaning a metal mask; a second cleaner for cleaning the metal mask using water of a water pipe; a pneumatic drier for drying the metal mask; and an electric-circuited panel board for controlling all operations of each of the constituent elements.

### BACKGROUND OF THE INVENTION

1. Field of the Invention

The present invention relates to an automatic cleaning device for a metal mask and a control method thereof, and more particularly, to a device for automatically cleaning and removing a remaining solder after completion of a metal mask (screen mask) process of a print process for coating a paste solder for electric connection (conduction) of a component and a printed circuit board on the printed circuit board, in a process of mounting the component on the printed circuit board in an electronic manufacture field.

2. Description of the Related Art

As a conventional method for cleaning a metal mask, there have been used a method for spraying and artificially wiping an isopropyl alcoholic based cleaning solution on a printed circuit board comprised of a thin SUS, through a sprayer, and a method for automatically cleaning a surface of the metal mask using oscillation or wavelength of an ultrasonic wave.

However, the former method has a drawback in that when a foreign solder material is wiped with a cloth from a small hole (minute opening) perforated through the printed circuit board adaptively to a position of a copperplate, it is difficult to completely clean the foreign solder material from the small hole, and since the cleaning solution and the foreign solder material are blown away into the air in a form of powder due to the use of a pneumatic sprayer, an environmental harm is caused.

The latter method has a first drawback in that due to the use of electricity, fire/electric leakage occurs during a working and drying operation depending on a kind of the cleaning solution, a second drawback in that a cost is incurred depending on a cycle of exchange/repair of an ultrasonic oscillator, and a third drawback in that when the minute opening is cleaned, ultrasonic wave fusion is caused by a solder cream remaining within the opening due to an insufficient cleaning solution.

Meantime, in order to improve the drawbacks and limitations of the conventional cleaning device, Korean Utility Model Registration No. 0272137 discloses a pneumatic automatic cleaning device and a cleaning method using the cleaning device where a high-pressure air, which is generated when the cleaning solution stored in a cleaning tank is circulated using a pump, is sprayed through a small hole of a nozzle, thereby cleaning a metal mask and removing a remaining cleaning solution using the nozzle connected with an air heater.

However, the above cleaning method has a drawback in that due to absence of a separate device for heating the cleaning solution whose temperature generally varies depending on a place at which the cleaner is located, a season, and an environmental cause, within the cleaning tank, the cleaning solution cannot be constantly maintained in temperature and accordingly, a choice for the cleaning solution having an excellent detergency irrespective of the temperature is limited due to a consideration of a cost and the like.

Further, in case where the remaining cleaning solution is removed using the nozzle connected with the air heater, the nozzle sprays only in a vertical direction to the printed circuit board and therefore, there is a drawback in that the remaining cleaning solution cannot be completely removed from the SUS surface and, when the cleaning solution is removed using a hot heater, it is harmful to man due to its vaporization.

### SUMMARY OF THE INVENTION

Accordingly, the present invention is directed to an automatic cleaning device for a metal mask and a control method thereof that substantially overcome one or more of the limitations and disadvantages of the conventional art.

One object of the present invention is to provide an automatic cleaning device for a metal mask, having a separate temperature controller for maintaining or controlling a temperature of cleaning solution, and having an improved cleaner for providing excellent secondary water cleaning and detergency, thereby completely removing a foreign remainder from an SUS surface of a metal mask with no harm to man, and a control method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a automatic cleaning device for a metal mask, the device including: a temperature controller for maintaining and increasing a temperature of cleaning solution; a first cleaner for keeping, circulating and spraying the cleaning solution mixable with water, and cleaning a metal mask; a second cleaner for cleaning the metal mask using water of a water pipe; a pneumatic drier for drying the metal mask; and an electric-circuited panel board for controlling all operations of each of the constituent elements.

In another aspect of the present invention, there is provided a method of controlling an automatic cleaning device for a metal mask, the method including: a cleaning solution supplying and preheating step; a primary cleaning step using the cleaning solution; a primary pneumatic drying step; a secondary cleaning step using water ; and a secondary pneumatic drying step, wherein each of the steps is subsequently repeated depending on a predetermined time and number of times.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of an automatic cleaning device for a metal mask according to an embodiment of the present invention;

FIG. 2 is an exploded sectional view illustrating an “A” portion of FIG. 1; and

FIG. 3 is a flowchart illustrating a control method of an automatic cleaning device for a metal mask according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

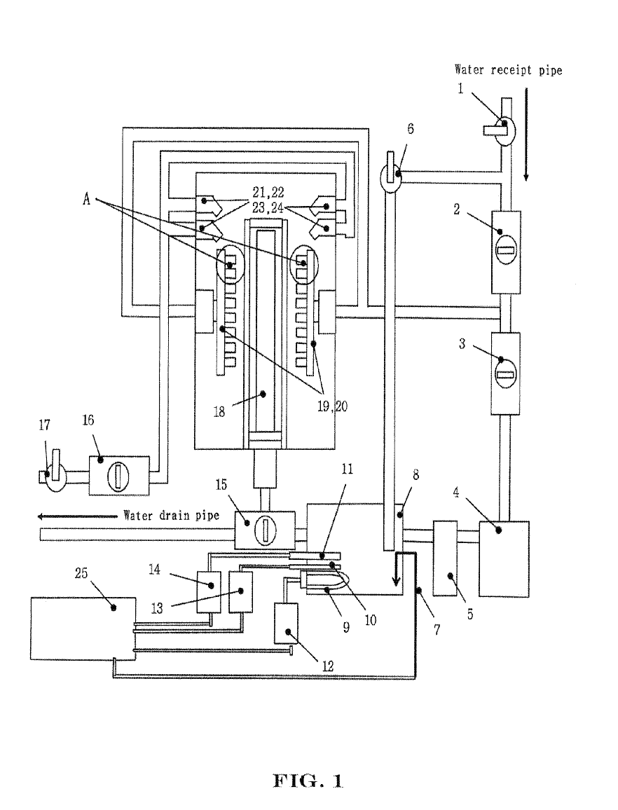

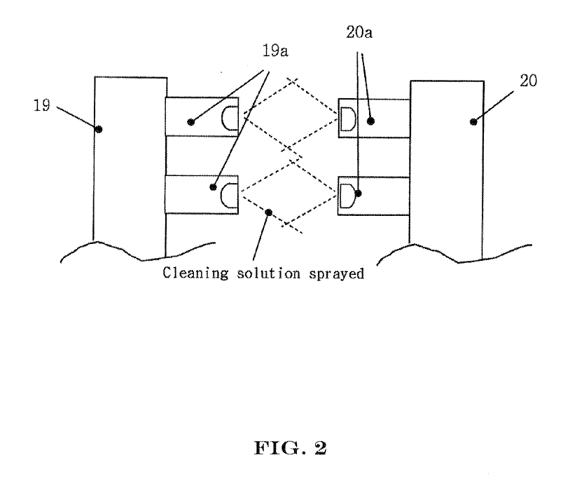

FIG. 1 illustrates a construction of an automatic cleaning device for a metal mask according to an embodiment of the present invention, and FIG. 2 is an exploded sectional view illustrating an “A” portion of FIG. 1.

The inventive automatic cleaning device mainly includes a temperature controller for maintaining or increasing a temperature of cleaning solution; a first cleaner for cleaning a metal mask by keeping, circulating and spraying the cleaning solution mixable with water; a second cleaner for cleaning a metal mask using water of a water pipe; a pneumatic drier for drying the metal mask; and a panel board for controlling all operations of the above constituent elements.

The temperature controller includes a tank 8 for keeping the cleaning solution; a pipe heater 9 disposed to pass through the tank 8; an electronic relay 12 for applying a voltage to activate the heater 9; a first thermocouple 10 for measuring a temperature of the heater 9; a thermostat 13 installed for safety; a second thermocouple 11 for measuring a temperature of water; and a water level sensor 7 for controlling the temperature of water.

The first cleaner includes a valve 6 for opening and closing the water pipe; the tank 8 for keeping the cleaning solution; a filter 5 for collecting a foreign solder material; an electric pump 4 electrically driven and circulating the cleaning solution; a check valve 3 and hydraulic rotators 19 and 20; a plurality of nozzles 19a and 19b for bifurcating and spraying at an angle of 45°; and a check valve 15 for switching toward the tank 8.

The second cleaner includes a valve 1 for opening and closing the water pipe; a check valve 2; hydraulic rotators 19 and 20; the plurality of nozzles 19a and 20a for bifurcating and spraying at an angle of 45°; and a check valve for switching for water drain.

In particular, in the first and second cleaners, as shown in FIG. 2, the plurality of nozzles are installed at front ends of the hydraulic rotators 19 and 20, and have semicircular holes at their front portions from which the cleaning solution is discharged, to enable the cleaning solution or water to be bifurcated and discharged at the angle of 45°.

The drier includes a valve 17 for opening and closing a pneumatic pipe; a check valve 16; and pneumatic spraying nozzles 21, 22, 23 and 24 each installed at an angle of 45°.

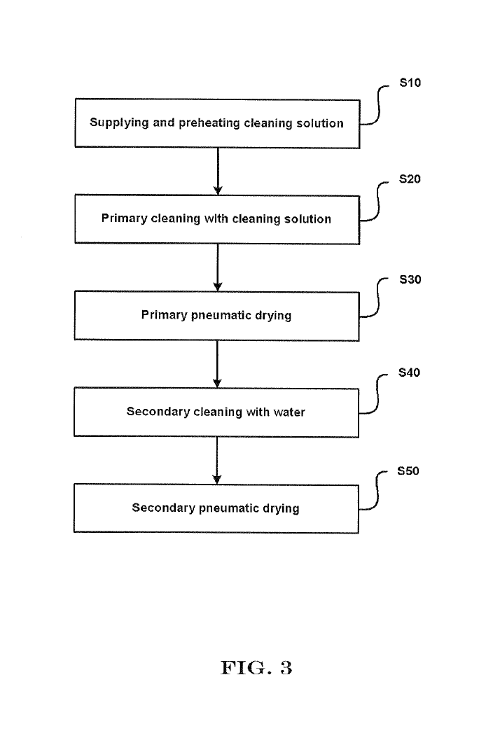

An operation of the automatic cleaning device for the metal mask according to an embodiment of the present invention will be described in detail with reference to FIG. 3 below.

The operation of the inventive automatic cleaning device mainly is performed through the steps of supplying and preheating the cleaning solution (Step 10); a primary cleaning step using the cleaning solution (Step 20); a primary pneumatic drying step (Step 30); a secondary cleaning step using water (Step 40); and a secondary pneumatic drying step (Step 50). Each step is subsequently repeated depending on a predetermined time and number of times.

In the cleaning solution supplying and preheating step (Step 10), the water pipe opening and closing valve 1 is opened, and the water pipe opening and closing valve 2 is opened, thereby supplying water to the tank 8.

If an appropriate amount of water is supplied to the tank 8, the water pipe opening and closing valve 6 is closed while supply of water is stopped, and the cleaning solution is put into the tank 8 and is mixed with water.

After that, a temperature controller 14 checks a current temperature of cleaning solvent, which is obtained by mixing the water with the cleaning solution, through the water sensing thermocouple 11. If it is determined to be a low temperature on the basis of a preset value, a voltage is applied to the electronic relay 12 by the panel board 25, and the pipe heater 9 is activated to increase the temperature of the cleaning solvent.

The heater temperature is measured using the heater temperature sensing thermocouple 10 installed at the pipe heater 8. If it is measured to be more than a predetermined temperature of the safety thermostat 13, the voltage applied to the electronic relay 12 is cut off using the panel board 25 to prevent overheating of the heater 8.

Subsequently, in order to maintain the cleaning solvent at an appropriate temperature, a process of cutting off the voltage supplied to the electronic relay 12 using the electronic-circuited panel board 25 when the water temperature sensed in the water sensing thermocouple 11 is increased more than an upper limit value preset to the temperature controller 14, and again supplying the voltage to the electronic relay 12 when the water temperature is decreased less than a lower limit value preset to the temperature controller 14, is repeated.

Meanwhile, the electronic-circuited panel board 25 causes the automatic cleaning device not to perform the following steps until the cleaning solvent reaches a position at which the water level sensor 7 is installed within the tank 8.

Next, in the primary cleaning step (Step 20) using the cleaning solution, first, the check valve 3 is switched and opened, and the electric pump 4 is operated to cause the cleaning solution within the tank 8 to be sprayed to the SUS surface of the metal mask 1 8 through the plurality of nozzles 19a and 20a installed at the front ends of the hydraulic rotators 19 and 20, via a micro filter 5, the electric pump 4, and the check valve 3 through a pipe.

When the check valve 15 is opened toward the tank 8, the cleaning solution sprayed to and streaming down from the SUS surface is introduced into the tank 8. The above step is repeated during a set time based on the control of the electronic panel board 25.

Next, in the primary pneumatic drying step (Step 30), first, if the set time based on the control of the panel board 25 is completed, the electric pump 4 is stopped, and when the check valve 3 is switched and closed, a circulating and spraying operation of the cleaning solution is no longer performed.

However, even at this time, the check valve 15 is continuously maintained and opened toward the tank 8 in consideration of the introduction of the earlier sprayed cleaning solution.

After that, when the pneumatic opening and closing valve 17 is switched for supply and the check valve 1 6 is switched and opened, a high pressure air is sprayed from the plurality of pneumatic spraying nozzles 21, 22, 23, and 24 that are disposed to be slant at the angle of 45° about the SUS surface of the metal mask 1 8, thereby primarily drying the metal mask 18, and the above step is repeated during the set time based on the control of the electric-circuited panel board 25.

After that, in the secondary cleaning step using water (Step 40), the water pipe opening and closing valve 1 is opened and the check valve 2 is switched and opened, thereby spraying water to the SUS surface of the metal mask 18 through the plurality of nozzles installed at the front ends of the hydraulic rotators 19 and 20, via the pipe.

The water sprayed to and streaming down from the SUS surface of the metal mask 18 is discharged to the water pipe by switching the check valve 15 toward the water pipe, and the step is repeated during the set time based on the control of the panel board 25.

Next, in the secondary pneumatic drying step (Step 50), first, when the set time based on the control of the panel board 25 is completed, the check valve 3 is switched and closed, thereby no longer circulating and spraying water.

However, even at this time, the check valve 15 is maintained to allow water to flow toward the water pipe in consideration of the introduction of the earlier sprayed water.

After that, when the pneumatic opening and closing valve 17 is switched for supply and the check valve 16 is switched and opened, a high pressure air is sprayed from the plurality of pneumatic spraying nozzles 21, 22, 23, and 24 that are disposed to be slant at the angle of 45° about the SUS surface of the metal mask 18, thereby primarily drying the metal mask 18, and the above step is repeated during the set time based on the control of the electric-circuited panel board 25.

As described above, according to the present invention, the cleaning solution can be maintained and controlled in temperature, thereby not being under the influence of installation place and season of the automatic cleaning device, and the cleaner is improved to provide excellent secondary water cleaning and detergency, thereby completely removing a foreign remainder from the SUS surface of the metal mask and also providing an environment-friendly effect of giving no harm to man.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An automatic cleaning device for a metal mask, the device comprising:
a temperature controller for maintaining and increasing a temperature of cleaning solution;
a first cleaner for cleaning a metal mask by keeping, circulating, and spraying the cleaning solution mixable with water;
a second cleaner for cleaning the metal mask using water of a water pipe;
a pneumatic drier for drying the metal mask; and
an electric-circuited panel board for controlling all operations of each of the constituent elements.

2. The device according to claim 1, wherein the temperature controller comprises:
a tank for keeping the cleaning solution;
a pipe heater disposed to pass through the tank;
an electronic relay for applying a voltage to activate the heater;
a first thermocouple for measuring a temperature of the heater;
a thermostat installed for safety;
a second thermocouple for measuring a temperature of water; and
a water level sensor for controlling the temperature of water.

3. The device according to claim 1, wherein the first cleaner comprises:
a valve for opening and closing a water pipe;
a tank for keeping the cleaning solution;
a filter for collecting a foreign solder material;
an electric pump electrically driven and circulating the cleaning solution;
a check valve;
hydraulic rotators;
a plurality of nozzles for bifurcating and spraying the cleaning solution at an angle of 45°; and
a check valve for switching toward the tank.

4. The device according to claim 1, wherein the second cleaner comprises:
a valve for opening and closing water pipe;
a check valve;
hydraulic rotators;
a plurality of nozzles for bifurcating and spraying water at an angle of 45°; and
a check valve for switching for water drain.

5. The device according to claim 1, wherein the drier comprises:
a valve for opening and closing a pneumatic pipe;
a check valve; and
a pneumatic spraying nozzle installed at an angle of 45°.

6. A method of controlling an automatic cleaning device for a metal mask, the method comprising:
a cleaning solution supplying and preheating step;
a primary cleaning step using cleaning solution;
a primary pneumatic drying step;
a secondary cleaning step using water; and
a secondary pneumatic drying step,
wherein each of the steps is subsequently repeated depending on a predetermined time and number of times.
